(19) United States
(12) Patent Application Publication
(10) Pub. No.: US 2009/0323341 A1
(43) Pub. Date: Dec. 31, 2009

(54) Convective cooling based lighting fixtures

(75) Inventor: Clarence Chui, Los Altos Hills, CA (US)

Correspondence Address: VAN PELT, YI & JAMES LLP, 10050 N. FOOTHILL BLVD #200, CUPERTINO, CA, 95014, US

(73) Assignee: Boundary Net, Incorporated

(21) Appl. No.: 12/380,588

(22) Filed: Feb. 27, 2009

Related U.S. Application Data
(63) Continuation-in-part of application No. 11/906,770, filed on Oct. 2, 2007.
(60) Provisional application No. 60/966,549, filed on Jun. 28, 2007.
(60) Provisional application No. 61/208,824, filed on Feb. 26, 2009.

(51) Int. Cl. F21S 4/00; F21V 29/00

(52) U.S. Cl. 362/249.02; 362/373; 362/294

(57) ABSTRACT

Convective cooling based lighting fixtures are disclosed. In some embodiments, a lighting fixture comprises a paddle configured to move in one or more directions and a set of one or more heat generating lighting elements mounted on the paddle. The motion of the paddle results in convective cooling of the set of lighting elements.

### CROSS REFERENCE TO OTHER APPLICATIONS

This application is a continuation in part of co-pending U.S. patent application Ser. No. 11/906,770, entitled COMPOSITE DISPLAY and filed Oct. 2, 2007, which is incorporated herein by reference for all purposes and which claims priority to U.S. Provisional Patent Application No. 60/966,549, entitled COMPOSITE DISPLAY and filed Jun. 28, 2007, which is incorporated herein by reference for all purposes.

This application claims priority to U.S. Provisional patent application Ser. No. ______ (Attorney Docket No. BOUNP014+), entitled CONVECTIVE COOLING BASED LIGHTING FIXTURES and filed Feb. 26, 2009, which is incorporated herein by reference for all purposes.

### BACKGROUND OF THE INVENTION

Metal halide lighting fixtures are typically employed for spotlights, stadium lighting, and other high power applications. Various characteristics of metal halide technology, however, are non-ideal. For example, compared to other lighting technologies, metal halide lighting fixtures consume a lot of power, require long warm-up times when turned on, produce a fixed luminance or brightness that cannot be altered (e.g., dimmed), comprise large mechanical structures, and have relatively short lifetimes.

Other lighting technologies, such as solid state light emitting diodes (LEDs), have not yet been satisfactorily adapted for high power applications due to thermal issues arising from the large amount of heat generated in high power applications. For example, LEDs have been successfully employed in low power applications. However, higher power applications have required substantial fans and/or heat sinks to provide thermal management, preventing LEDs from being a scalable solution for high power lighting applications.

### BRIEF DESCRIPTION OF THE DRAWINGS

Various embodiments of the invention are disclosed in the following detailed description and the accompanying drawings.

FIG. 1 is a diagram illustrating an embodiment of a composite display having a single paddle.

FIG. 2A is a diagram illustrating an embodiment of a paddle used in a composite display.

FIG. 2B illustrates an example of temporal pixels in a sweep plane.

FIG. 3 is a diagram illustrating an embodiment of a composite display having two paddles.

FIG. 4A illustrates examples of paddle installations in a composite display.

FIG. 4B is a diagram illustrating an embodiment of a composite display that uses masks.

FIG. 4C is a diagram illustrating an embodiment of a composite display that uses masks.

FIG. 5 is a block diagram illustrating an embodiment of a system for displaying an image.

FIG. 6A is a diagram illustrating an embodiment of a composite display having two paddles.

FIG. 6B is a flowchart illustrating an embodiment of a process for generating a pixel map.

FIG. 7 illustrates examples of paddles arranged in various arrays.

FIG. 8 illustrates examples of paddles with coordinated in phase motion to prevent mechanical interference.

FIG. 9 illustrates examples of paddles with coordinated out of phase motion to prevent mechanical interference.

FIG. 10 is a diagram illustrating an example of a cross section of a paddle in a composite display.

FIG. 11A is a diagram illustrating an embodiment of a cross section of a lighting fixture.

FIG. 11B is a diagram illustrating an embodiment of a cross section of a lighting fixture.

FIG. 11C is a diagram illustrating an embodiment of a cross section of a lighting fixture.

FIG. 12A illustrates an embodiment of a circularly shaped paddle.

FIG. 12B illustrates an embodiment of an oblong paddle.

FIG. 12C illustrates an embodiment of a fan-shaped paddle.

FIG. 13A is a diagram illustrating an embodiment of a cross section of a portion of a standard LED package.

FIG. 13B is a diagram illustrating an embodiment of a cross section of a portion of an LED package that facilitates heat dissipation via the top surface of the LED.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims, and the invention encompasses numerous alternatives, modifications, and equivalents. Numerous specific details are set forth in the following description in order to provide a thorough understanding of the invention. These details are provided for the purpose of example, and the invention may be practiced according to the claims without some or all of these specific details. For the purpose of clarity, technical material that is known in the technical fields related to the invention has not been described in detail so that the invention is not unnecessarily obscured.

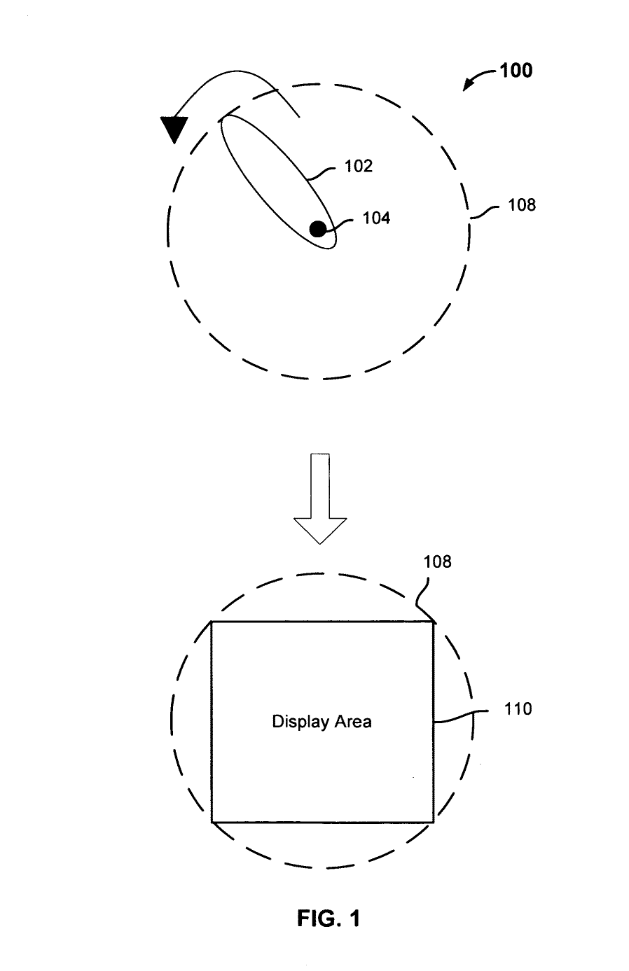

FIG. 1 is a diagram illustrating an embodiment of a composite display 100 having a single paddle. In the example shown, paddle 102 is configured to rotate at one end about axis of rotation 104 at a given frequency, such as 60 Hz. Paddle 102 sweeps out area 108 during one rotation or paddle cycle. A plurality of pixel elements, such as LEDs, is installed on paddle 102. As used herein, a pixel element refers to any element that may be used to display at least a portion of image information. As used herein, image or image information may include image, video, animation, slideshow, or any other visual information that may be displayed. Other examples of pixel elements include: laser diodes, phosphors, cathode ray tubes, liquid crystal, any transmissive or emissive optical modulator. Although LEDs may be described in the examples herein, any appropriate pixel elements may be used. In various embodiments, LEDS may be arranged on paddle 102 in a variety of ways, as more fully described below.

As paddle 102 sweeps out area 108, one or more of its LEDs are activated at appropriate times such that an image or a part thereof is perceived by a viewer who is viewing swept area 108. An image is comprised of pixels each having a spatial location. It can be determined at which spatial location a particular LED is at any given point in time. As paddle 102 rotates, each LED can be activated as appropriate when its location coincides with a spatial location of a pixel in the image. If paddle 102 is spinning fast enough, the eye perceives a continuous image. This is because the eye has a poor frequency response to luminance and color information. The eye integrates color that it sees within a certain time window. If a few images are flashed in a fast sequence, the eye integrates that into a single continuous image. This low temporal sensitivity of the eye is referred to as persistence of vision.

As such, each LED on paddle 102 can be used to display multiple pixels in an image. A single pixel in an image is mapped to at least one “temporal pixel” in the display area in composite display 100. A temporal pixel can be defined by a pixel element on paddle 102 and a time (or angular position of the paddle), as more fully described below.

The display area for showing the image or video may have any shape. For example, the maximum display area is circular and is the same as swept area 108. A rectangular image or video may be displayed within swept area 108 in a rectangular display area 110 as shown.

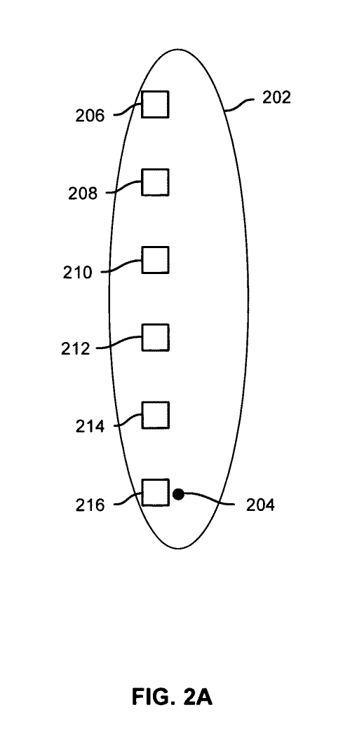

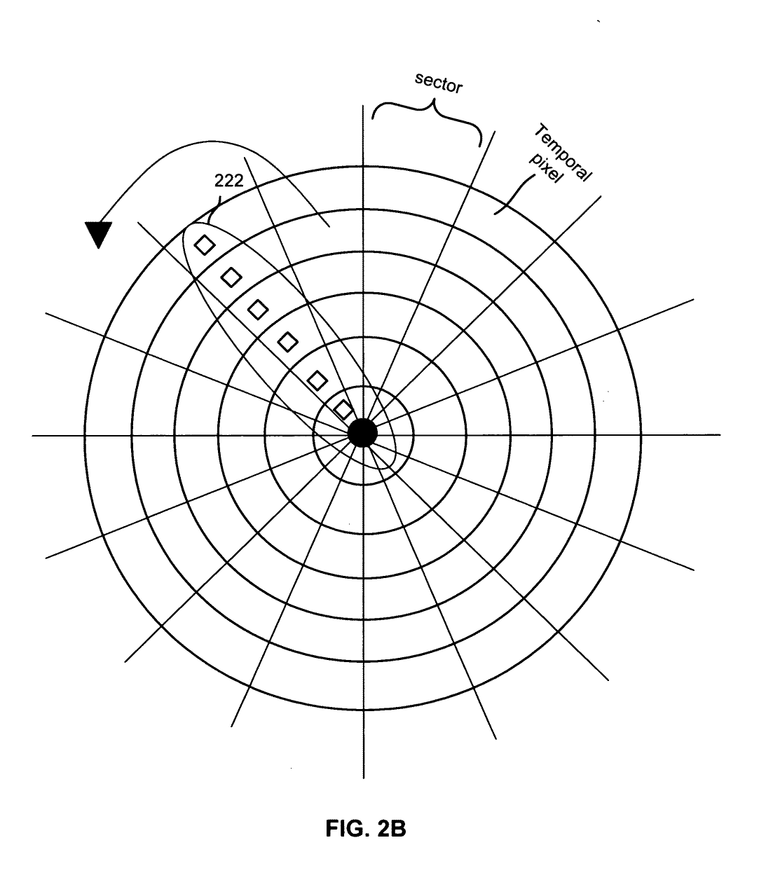

FIG. 2A is a diagram illustrating an embodiment of a paddle used in a composite display. For example, paddle 202, 302, or 312 (discussed later) may be similar to paddle 102. Paddle 202 is shown to include a plurality of LEDs 206-216 and an axis of rotation 204 about which paddle 202 rotates. LEDs 206-216 may be arranged in any appropriate way in various embodiments. In this example, LEDs 206-216 are arranged such that they are evenly spaced from each other and aligned along the length of paddle 202. They are aligned on the edge of paddle 202 so that LED 216 is adjacent to axis of rotation 204. This is so that as paddle 202 rotates, there is no blank spot in the middle (around axis of rotation 204). In some embodiments, paddle 202 is a PCB shaped like a paddle. In some embodiments, paddle 202 has an aluminum, metal, or other material casing for reinforcement.

FIG. 2B illustrates an example of temporal pixels in a sweep plane. In this example, each LED on paddle 222 is associated with an annulus (area between two circles) around the axis of rotation. Each LED can be activated once per sector (angular interval). Activating an LED may include, for example, turning on the LED for a prescribed time period (e.g., associated with a duty cycle) or turning off the LED. The intersections of the concentric circles and sectors form areas that correspond to temporal pixels. In this example, each temporal pixel has an angle of 42.5 degrees, so that there are a total of 16 sectors during which an LED may be turned on to indicate a pixel. Because there are 6 LEDs, there are 6*16=96 temporal pixels. In another example, a temporal pixel may have an angle of 1/10 of a degree, so that there are a total of 3600 angular positions possible.

Because the spacing of the LEDs along the paddle is uniform in the given example, temporal pixels get denser towards the center of the display (near the axis of rotation). Because image pixels are defined based on a rectangular coordinate system, if an image is overlaid on the display, one image pixel may correspond to multiple temporal pixels close to the center of the display. Conversely, at the outermost portion of the display, one image pixel may correspond to one or a fraction of a temporal pixel. For example, two or more image pixels may fit within a single temporal pixel. In some embodiments, the display is designed (e.g., by varying the sector time or the number/placement of LEDs on the paddle) so that at the outermost portion of the display, there is at least one temporal pixel per image pixel. This is to retain in the display the same level of resolution as the image. In some embodiments, the sector size is limited by how quickly LED control data can be transmitted to an LED driver to activate LED(s). In some embodiments, the arrangement of LEDs on the paddle is used to make the density of temporal pixels more uniform across the display. For example, LEDs may be placed closer together on the paddle the farther they are from the axis of rotation.

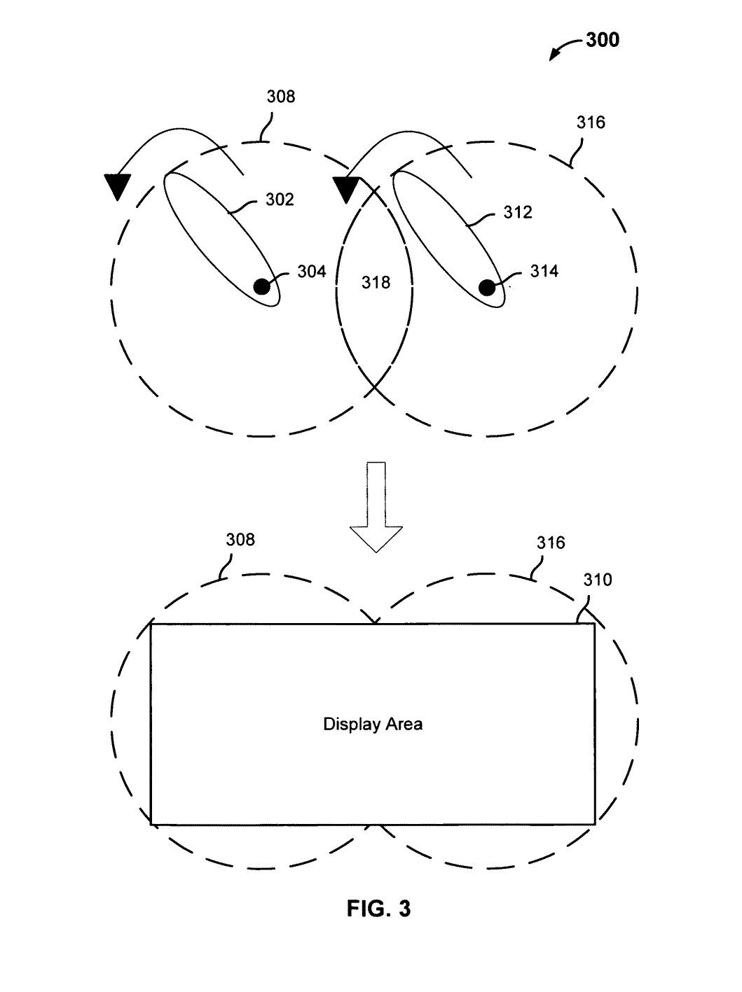

FIG. 3 is a diagram illustrating an embodiment of a composite display 300 having two paddles. In the example shown, paddle 302 is configured to rotate at one end about axis of rotation 304 at a given frequency, such as 60 Hz. Paddle 302 sweeps out area 308 during one rotation or paddle cycle. A plurality of pixel elements, such as LEDs, is installed on paddle 302. Paddle 312 is configured to rotate at one end about axis of rotation 314 at a given frequency, such as 60 Hz. Paddle 312 sweeps out area 316 during one rotation or paddle cycle. A plurality of pixel elements, such as LEDs, is installed on paddle 312. Swept areas 308 and 316 have an overlapping portion 318.

Using more than one paddle in a composite display may be desirable in order to make a larger display. For each paddle, it can be determined at which spatial location a particular LED is at any given point in time, so any image can be represented by a multiple paddle display in a manner similar to that described with respect to FIG. 1. In some embodiments, for overlapping portion 318, there will be twice as many LEDs passing through per cycle than in the nonoverlapping portions. This may make the overlapping portion of the display appear to the eye to have higher luminance. Therefore, in some embodiments, when an LED is in an overlapping portion, it may be activated half the time so that the whole display area appears to have the same luminance. This and other examples of handling overlapping areas are more fully described below.

The display area for showing the image or video may have any shape. The union of swept areas 308 and 316 is the maximum display area. A rectangular image or video may be displayed in rectangular display area 310 as shown.

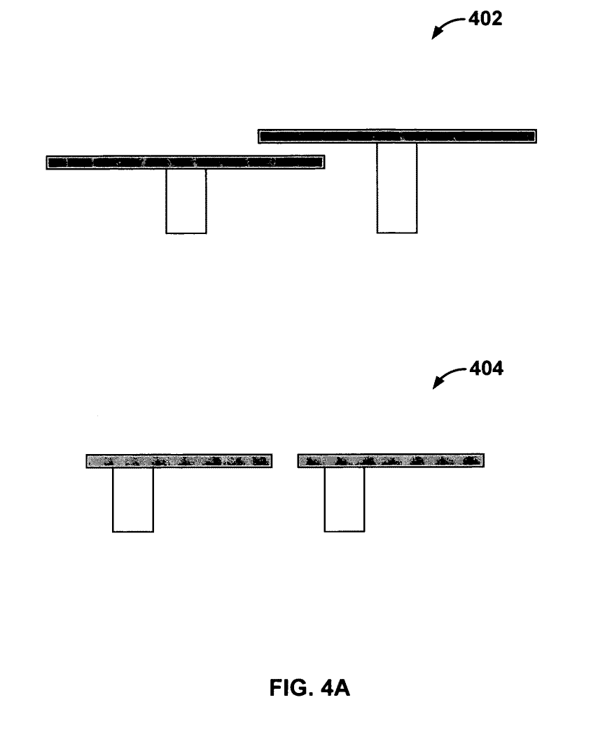

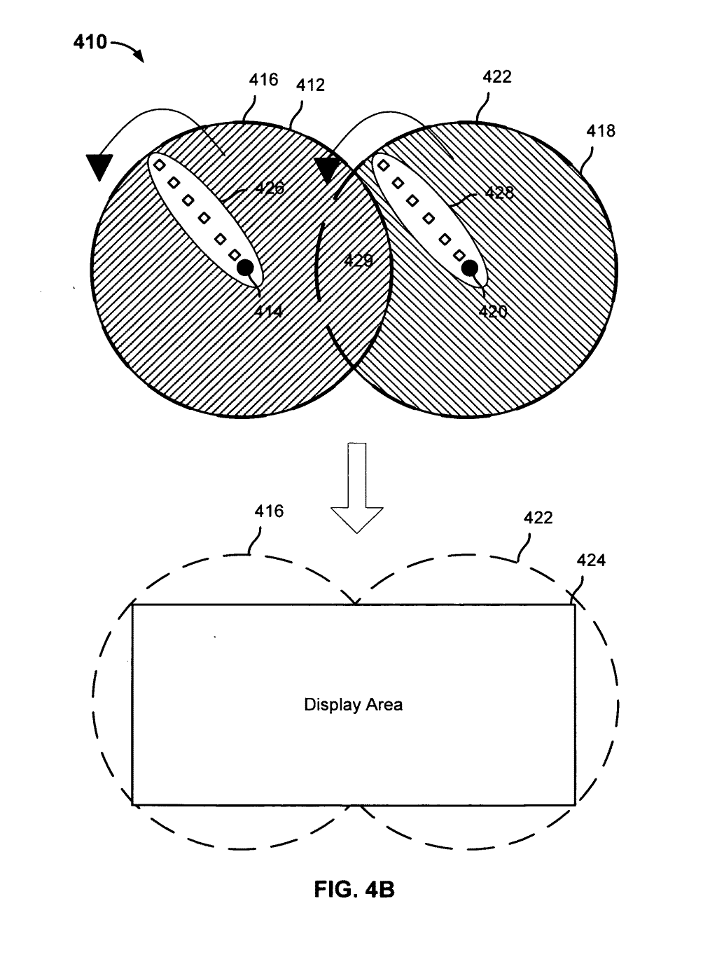

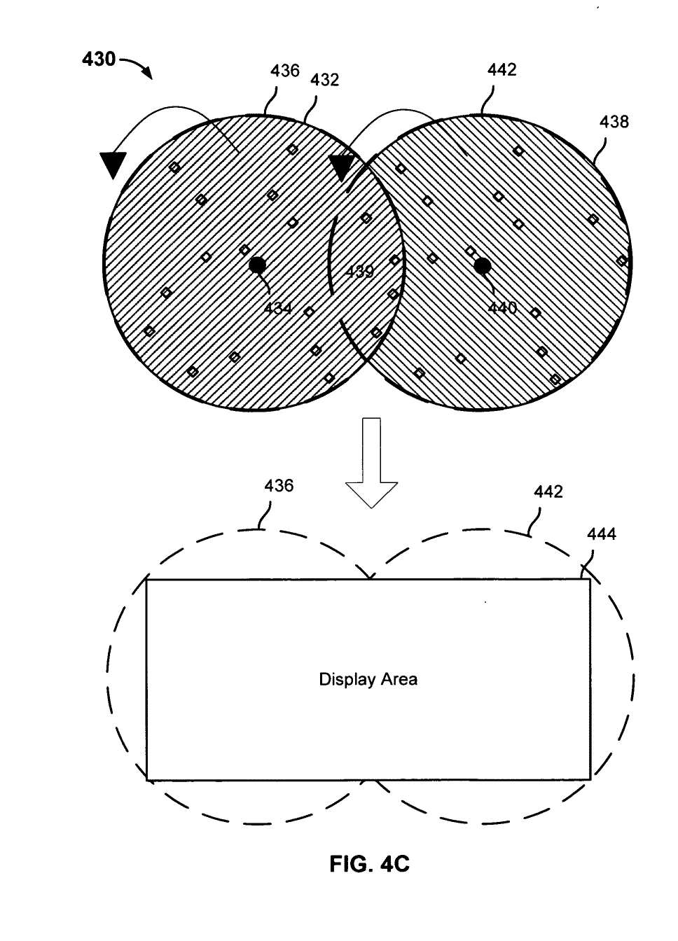

When using more than one paddle, there are various ways to ensure that adjacent paddles do not collide with each other. FIG. 4A illustrates examples of paddle installations in a composite display. In these examples, a cross section of adjacent paddles mounted on axes is shown.

In diagram 402, two adjacent paddles rotate in vertically separate sweep planes, ensuring that the paddles will not collide when rotating. This means that the two paddles can rotate at different speeds and do not need to be in phase with each other. To the eye, having the two paddles rotate in different sweep planes is not detectable if the resolution of the display is sufficiently smaller than the vertical spacing between the sweep planes. In this example, the axes are at the center of the paddles. This embodiment is more fully described below.

In diagram 404, the two paddles rotate in the same sweep plane. In this case, the rotation of the paddles is coordinated to avoid collision. For example, the paddles are rotated in phase with each other. Further examples of this are more fully described below.

In the case of the two paddles having different sweep planes, when viewing display area 310 from a point that is not normal to the center of display area 310, light may leak in diagonally between sweep planes. This may occur, for example, if the pixel elements emit unfocused light such that light is emitted at a range of angles. In some embodiments, a mask is used to block light from one sweep plane from being visible in another sweep plane. For example, a mask is placed behind paddle 302 and/or paddle 312. The mask may be attached to paddle 302 and/or 312 or stationary relative to paddle 302 and/or paddle 312. In some embodiments, paddle 302 and/or paddle 312 is shaped differently from that shown in FIGS. 3 and 4A, e.g., for masking purposes. For example, paddle 302 and/or paddle 312 may be shaped to mask the sweep area of the other paddle.

FIG. 4B is a diagram illustrating an embodiment of a composite display 410 that uses masks. In the example shown, paddle 426 is configured to rotate at one end about axis of rotation 414 at a given frequency, such as 60 Hz. A plurality of pixel elements, such as LEDs, is installed on paddle 426. Paddle 426 sweeps out area 416 (bold dashed line) during one rotation or paddle cycle. Paddle 428 is configured to rotate at one end about axis of rotation 420 at a given frequency, such as 60 Hz. Paddle 428 sweeps out area 422 (bold dashed line) during one rotation or paddle cycle. A plurality of pixel elements, such as LEDs, is installed on paddle 428.

In this example, mask 412 (solid line) is used behind paddle 426. In this case, mask 412 is the same shape as area 416 (i.e., a circle). Mask 412 masks light from pixel elements on paddle 428 from leaking into sweep area 416. Mask 412 may be installed behind paddle 426. In some embodiments, mask 412 is attached to paddle 426 and spins around axis of rotation 414 together with paddle 426. In some embodiments, mask 412 is installed behind paddle 426 and is stationary with respect to paddle 426. In this example, mask 418 (solid line) is similarly installed behind paddle 428.

In various embodiments, mask 412 and/or mask 418 may be made out of a variety of materials and have a variety of colors. For example, masks 412 and 418 may be black and made out of plastic.

The display area for showing the image or video may have any shape. The union of swept areas 416 and 422 is the maximum display area. A rectangular image or video may be displayed in rectangular display area 424 as shown.

Areas 416 and 422 overlap. As used herein, two elements (e.g., sweep area, sweep plane, mask, pixel element) overlap if they intersect in an x-y projection. In other words, if the areas are projected onto an x-y plane (defined by the x and y axes, where the x and y axes are in the plane of the figure), they intersect each other. Areas 416 and 422 do not sweep the same plane (do not have the same values of z, where the z axis is normal to the x and y axes), but they overlap each other in overlapping portion 429. In this example, mask 412 occludes sweep area 422 at overlapping portion 429 or occluded area 429. Mask 412 occludes sweep area 429 because it overlaps sweep area 429 and is on top of sweep area 429.

FIG. 4C is a diagram illustrating an embodiment of a composite display 430 that uses masks. In this example, pixel elements are attached to a rotating disc that functions as both a mask and a structure for the pixel elements. Disc 432 can be viewed as a circular shaped paddle. In the example shown, disc 432 (solid line) is configured to rotate at one end about axis of rotation 434 at a given frequency, such as 60 Hz. A plurality of pixel elements, such as LEDs, is installed on disc 432. Disc 432 sweeps out area 436 (bold dashed line) during one rotation or disc cycle. Disc 438 (solid line) is configured to rotate at one end about axis of rotation 440 at a given frequency, such as 60 Hz. Disc 438 sweeps out area 442 (bold dashed line) during one rotation or disc cycle. A plurality of pixel elements, such as LEDs, is installed on disc 438.

In this example, the pixel elements can be installed anywhere on discs 432 and 438. In some embodiments, pixel elements are installed on discs 432 and 438 in the same pattern. In other embodiments, different patterns are used on each disc. In some embodiments, the density of pixel elements is lower towards the center of each disc so the density of temporal pixels is more uniform than if the density of pixel elements is the same throughout the disc. In some embodiments, pixel elements are placed to provide redundancy of temporal pixels (i.e., more than one pixel is placed at the same radius). Having more pixel elements per pixel means that the rotation speed can be reduced. In some embodiments, pixel elements are placed to provide higher resolution of temporal pixels.

Disc 432 masks light from pixel elements on disc 438 from leaking into sweep area 436. In various embodiments, disc 432 and/or disc 438 may be made out of a variety of materials and have a variety of colors. For example, discs 432 and 438 may be black printed circuit board on which LEDs are installed.

The display area for showing the image or video may have any shape. The union of swept areas 436 and 442 is the maximum display area. A rectangular image or video may be displayed in rectangular display area 444 as shown.

Areas 436 and 442 overlap in overlapping portion 439. In this example, disc 432 occludes sweep area 442 at overlapping portion or occluded area 439.

In some embodiments, pixel elements are configured to not be activated when they are occluded. For example, the pixel elements installed on disc 438 are configured to not be activated when they are occluded, (e.g., overlap with occluded area 439). In some embodiments, the pixel elements are configured to not be activated in a portion of an occluded area. For example, an area within a certain distance from the edges of occluded area 439 is configured to not be activated. This may be desirable in case a viewer is to the left or right of the center of the display area and can see edge portions of the occluded area.

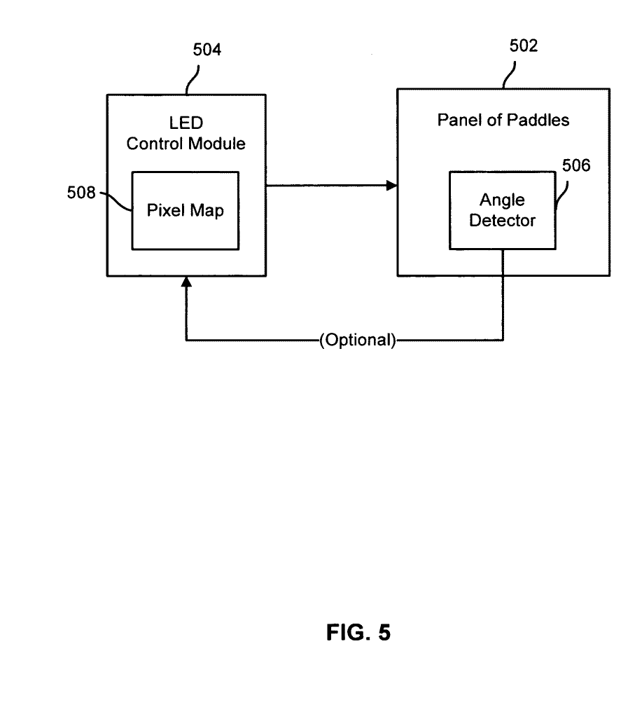

FIG. 5 is a block diagram illustrating an embodiment of a system for displaying an image. In the example shown, panel of paddles 502 is a structure comprising one or more paddles. As more fully described below, panel of paddles 502 may include a plurality of paddles, which may include paddles of various sizes, lengths, and widths; paddles that rotate about a midpoint or an endpoint; paddles that rotate in the same sweep plane or in different sweep planes; paddles that rotate in phase or out of phase with each other; paddles that have multiple arms; and paddles that have other shapes. Panel of paddles 502 may include all identical paddles or a variety of different paddles. The paddles may be arranged in a grid or in any other arrangement. In some embodiments, the panel includes angle detector 506, which is used to detect angles associated with one or more of the paddles. In some embodiments, there is an angle detector for each paddle on panel of paddles 502. For example, an optical detector may be mounted near a paddle to detect its current angle.

LED control module 504 is configured to optionally receive current angle information (e.g., angle(s) or information associated with angle(s)) from angle detector 506. LED control module 504 uses the current angles to determine LED control data to send to panel of paddles 502. The LED control data indicates which LEDs should be activated at that time (sector). In some embodiments, LED control module 504 determines the LED control data using pixel map 508. In some embodiments, LED control module 504 takes an angle as input and outputs which LEDs on a paddle should be activated at that sector for a particular image. In some embodiments, an angle is sent from angle detector 506 to LED control module 504 for each sector (e.g., just prior to the paddle reaching the sector). In some embodiments, LED control data is sent from LED control module 504 to panel of paddles 502 for each sector.

In some embodiments, pixel map 508 is implemented using a lookup table, as more fully described below. For different images, different lookup tables are used. Pixel map 508 is more fully described below.

In some embodiments, there is no need to read an angle using angle detector 506. Because the angular velocity of the paddles and an initial angle of the paddles (at that angular velocity) can be predetermined, it can be computed at what angle a paddle is at any given point in time. In other words, the angle can be determined based on the time. For example, if the angular velocity is ω, the angular location after time t is θᵢₙᵢₜᵢₐₗ+ωt where θᵢₙᵢₜᵢₐₗ is an initial angle once the paddle is spinning at steady state. As such, LED control module can serially output LED control data as a function of time (e.g., using a clock), rather than use angle measurements output from angle detector 506. For example, a table of time (e.g., clock cycles) versus LED control data can be built.

In some embodiments, when a paddle is starting from rest, it goes through a start up sequence to ramp up to the steady state angular velocity. Once it reaches the angular velocity, an initial angle of the paddle is measured in order to compute at what angle the paddle is at any point in time (and determine at what point in the sequence of LED control data to start).

In some embodiments, angle detector 506 is used periodically to provide adjustments as needed. For example, if the angle has drifted, the output stream of LED control data can be shifted. In some embodiments, if the angular speed has drifted, mechanical adjustments are made to adjust the speed.

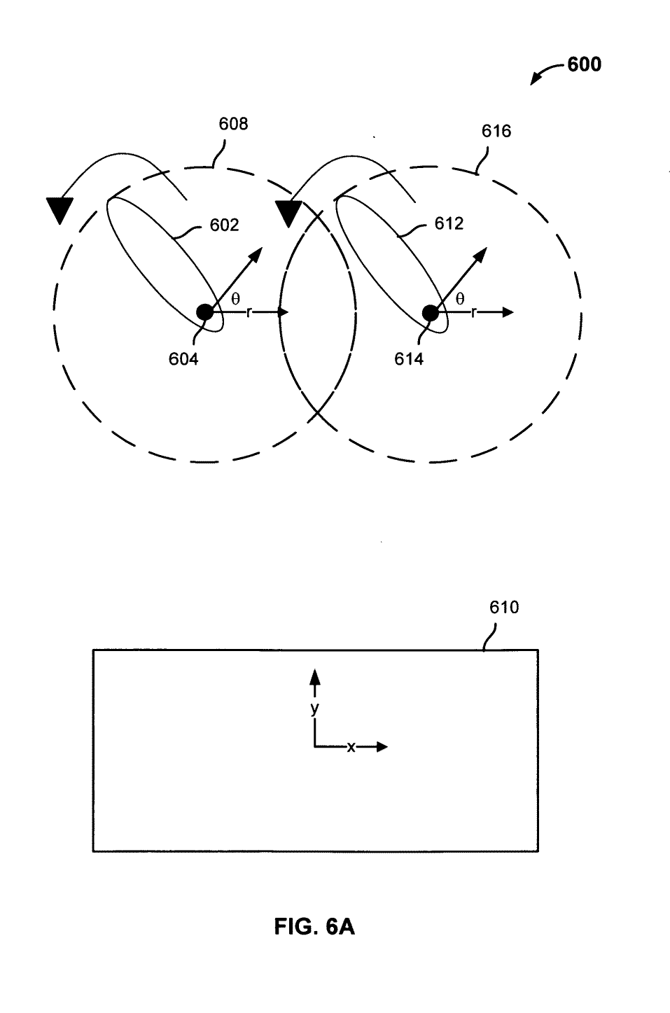

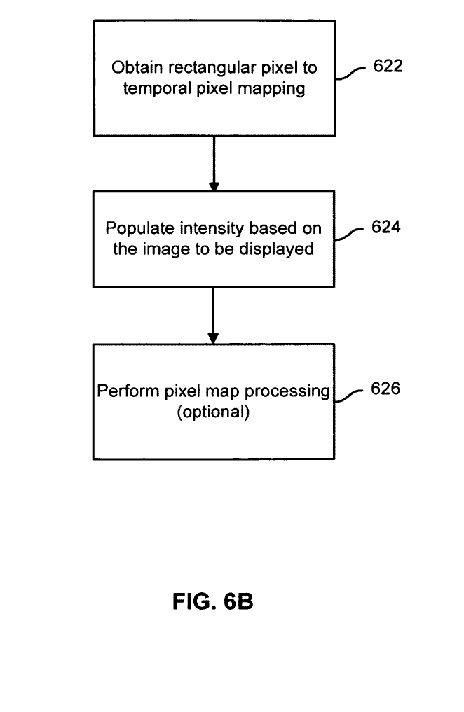

FIG. 6A is a diagram illustrating an embodiment of a composite display 600 having two paddles. In the example shown, a polar coordinate system is indicated over each of areas 608 and 616, with an origin located at each axis of rotation 604 and 614. In some implementations, the position of each LED on paddles 602 and 612 is recorded in polar coordinates. The distance from the origin to the LED is the radius r. The paddle angle is θ. For example, if paddle 602 is in the 3 o'clock position, each of the LEDs on paddle 602 is at 0 degrees. If paddle 602 is in the 12 o'clock position, each of the LEDs on paddle 602 is at 90 degrees. In some embodiments, an angle detector is used to detect the current angle of each paddle. In some embodiments, a temporal pixel is defined by P, r, and θ, where P is a paddle identifier and (r, θ) are the polar coordinates of the LED.

A rectangular coordinate system is indicated over an image 610 to be displayed. In this example, the origin is located at the center of image 610, but it may be located anywhere depending on the implementation. In some embodiments, pixel map 508 is created by mapping each pixel in image 610 to one or more temporal pixels in display area 608 and 616. Mapping may be performed in various ways in various embodiments.

FIG. 6B is a flowchart illustrating an embodiment of a process for generating a pixel map. For example, this process may be used to create pixel map 508. At 622, an image pixel to temporal pixel mapping is obtained. In some embodiments, mapping is performed by overlaying image 610 (with its rectangular grid of pixels (x, y) corresponding to the resolution of the image) over areas 608 and 616 (with their two polar grids of temporal pixels (r, θ), e.g., see FIG. 2B). For each image pixel (x, y), it is determined which temporal pixels are within the image pixel. The following is an example of a pixel map:

TABLE 1

| Image pixel (x, y) | Temporal Pixel (P, r, θ) | Intensity (f) |
|---|---|---|
| (a1, a2) | (b1, b2, b3) | |
| (a3, a4) | (b4, b5, b6); (b7, b8, b9) | |
| (a5, a6) | (b10, b11, b12) | |
| etc. | etc. | |

As previously stated, one image pixel may map to multiple temporal pixels as indicated by the second row. In some embodiments, instead of r, an index corresponding to the LED is used. In some embodiments, the image pixel to temporal pixel mapping is precomputed for a variety of image sizes and resolutions (e.g., that are commonly used).

At 624, an intensity f is populated for each image pixel based on the image to be displayed. In some embodiments, f indicates whether the LED should be on (e.g., 1) or off (e.g., 0). For example, in a black and white image (with no grayscale), black pixels map to f=1 and white pixels map to f=0. In some embodiments, f may have fractional values. In some embodiments, f is implemented using duty cycle management. For example, when f is 0, the LED is not activated for that sector time. When f is 1, the LED is activated for the whole sector time. When f is 0.5, the LED is activated for half the sector time. In some embodiments, f can be used to display grayscale images. For example, if there are 256 gray levels in the image, pixels with gray level 128 (half luminance) would have f=0.5. In some embodiments, rather than implement f using duty cycle (i.e., pulse width modulated), f is implemented by adjusting the current to the LED (i.e., pulse height modulation).

For example, after the intensity f is populated, the table may appear as follows:

TABLE 2

| Image pixel (x, y) | Temporal Pixel (P, r, θ) | Intensity (f) |
|---|---|---|
| (a1, a2) | (b1, b2, b3) | f1 |
| (a3, a4) | (b4, b5, b6); (b7, b8, b9) | f2 |
| (a5, a6) | (b10, b11, b12) | f3 |
| etc. | etc. | etc. |

At 626, optional pixel map processing is performed. This may include compensating for overlap areas, balancing luminance in the center (i.e., where there is a higher density of temporal pixels), balancing usage of LEDs, etc. For example, when LEDs are in an overlap area (and/or on a boundary of an overlap area), their duty cycle may be reduced. For example, in composite display 300, when LEDs are in overlap area 318, their duty cycle is halved. In some embodiments, there are multiple LEDs in a sector time that correspond to a single image pixel, in which case, fewer than all the LEDs may be activated (i.e., some of the duty cycles may be set to 0). In some embodiments, the LEDs may take turns being activated (e.g., every N cycles where N is an integer), e.g., to balance usage so that one doesn't burn out earlier than the others. In some embodiments, the closer the LEDs are to the center (where there is a higher density of temporal pixels), the lower their duty cycle.

For example, after luminance balancing, the pixel map may appear as follows:

TABLE 3

| Image pixel (x, y) | Temporal Pixel (P, r, θ) | Intensity (f) |
|---|---|---|
| (a1, a2) | (b1, b2, b3) | f1 |
| (a3, a4) | (b4, b5, b6) | f2 |
| (a5, a6) | (b10, b11, b12) | f3 |
| etc. | etc. | etc. |

As shown, in the second row, the second temporal pixel was deleted in order to balance luminance across the pixels. This also could have been accomplished by halving the intensity to f2/2. As another alternative, temporal pixel (b4, b5, b6) and (b7, b8, b9) could alternately turn on between cycles. In some embodiments, this can be indicated in the pixel map. The pixel map can be implemented in a variety of ways using a variety of data structures in different implementations.

For example, in FIG. 5, LED control module 504 uses the temporal pixel information (P, r, θ, and f) from the pixel map. LED control module 504 takes θ as input and outputs LED control data P, r, and f. Panel of paddles 502 uses the LED control data to activate the LEDs for that sector time. In some embodiments, there is an LED driver for each paddle that uses the LED control data to determine which LEDs to turn on, if any, for each sector time.

Any image (including video) data may be input to LED control module 504. In various embodiments, one or more of 622, 624, and 626 may be computed live or in real time, i.e., just prior to displaying the image. This may be useful for live broadcast of images, such as a live video of a stadium. For example, in some embodiments, 622 is precomputed and 624 is computed live or in real time. In some implementations, 626 may be performed prior to 622 by appropriately modifying the pixel map. In some embodiments, 622, 624, and 626 are all precomputed. For example, advertising images may be precomputed since they are usually known in advance.

The process of FIG. 6B may be performed in a variety of ways in a variety of embodiments. Another example of how 622 may be performed is as follows. For each image pixel (x, y), a polar coordinate is computed. For example, (the center of) the image pixel is converted to polar coordinates for the sweep areas it overlaps with (there may be multiple sets of polar coordinates if the image pixel overlaps with an overlapping sweep area). The computed polar coordinate is rounded to the nearest temporal pixel. For example, the temporal pixel whose center is closest to the computed polar coordinate is selected. (If there are multiple sets of polar coordinates, the temporal pixel whose center is closest to the computed polar coordinate is selected.) This way, each image pixel maps to at most one temporal pixel. This may be desirable because it maintains a uniform density of activated temporal pixels in the display area (i.e., the density of activated temporal pixels near an axis of rotation is not higher than at the edges). For example, instead of the pixel map shown in Table 1, the following pixel map may be obtained:

TABLE 4

| Image pixel (x, y) | Temporal Pixel (P, r, θ) | Intensity (f) |
|---|---|---|
| (a1, a2) | (b1, b2, b3) | |
| (a3, a4) | (b7, b8, b9) | |
| (a5, a6) | (b10, b11, b12) | |
| etc. | etc. | |

In some cases, using this rounding technique, two image pixels may map to the same temporal pixel. In this case, a variety of techniques may be used at 626, including, for example: averaging the intensity of the two rectangular pixels and assigning the average to the one temporal pixel; alternating between the first and second rectangular pixel intensities between cycles; remapping one of the image pixel to a nearest neighbor temporal pixel; etc.

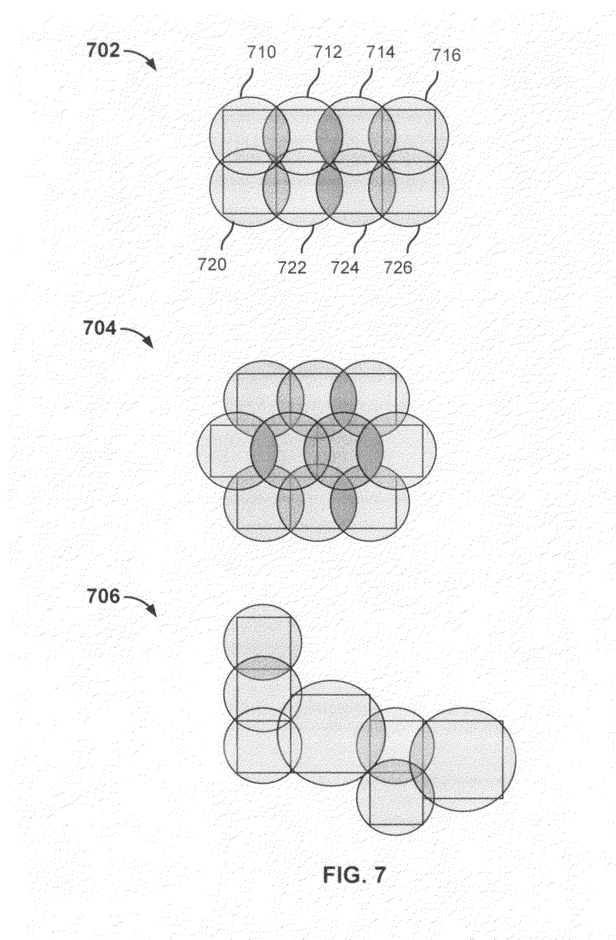

FIG. 7 illustrates examples of paddles arranged in various arrays. For example, any of these arrays may comprise panel of paddles 502. Any number of paddles may be combined in an array to create a display area of any size and shape.

Arrangement 702 shows eight circular sweep areas corresponding to eight paddles each with the same size. The sweep areas overlap as shown. In addition, rectangular display areas are shown over each sweep area. For example, the maximum rectangular display area for this arrangement would comprise the union of all the rectangular display areas shown. To avoid having a gap in the maximum display area, the maximum spacing between axes of rotation is \sqrt{2}R, where R is the radius of one of the circular sweep areas. The spacing between axes is such that the periphery of one sweep area does not overlap with any axes of rotation, otherwise there would be interference. Any combination of the sweep areas and rectangular display areas may be used to display one or more images.

In some embodiments, the eight paddles are in the same sweep plane. In some embodiments, the eight paddles are in different sweep planes. It may be desirable to minimize the number of sweep planes used. For example, it is possible to have every other paddle sweep the same sweep plane. For example, sweep areas 710, 714, 722, and 726 can be in the same sweep plane, and sweep areas 712, 716, 720, and 724 can be in another sweep plane.

In some configurations, sweep areas (e.g., sweep areas 710 and 722) overlap each other. In some configurations, sweep areas are tangent to each other (e.g., sweep areas 710 and 722 can be moved apart so that they touch at only one point). In some configurations, sweep areas do not overlap each other (e.g., sweep areas 710 and 722 have a small gap between them), which is acceptable if the desired resolution of the display is sufficiently low.

Arrangement 704 shows ten circular sweep areas corresponding to ten paddles. The sweep areas overlap as shown. In addition, rectangular display areas are shown over each sweep area. For example, three rectangular display areas, one in each row of sweep areas, may be used, for example, to display three separate advertising images. Any combination of the sweep areas and rectangular display areas may be used to display one or more images.

Arrangement 706 shows seven circular sweep areas corresponding to seven paddles. The sweep areas overlap as shown. In addition, rectangular display areas are shown over each sweep area. In this example, the paddles have various sizes so that the sweep areas have different sizes. Any combination of the sweep areas and rectangular display areas may be used to display one or more images. For example, all the sweep areas may be used as one display area for a non-rectangular shaped image, such as a cut out of a giant serpent.

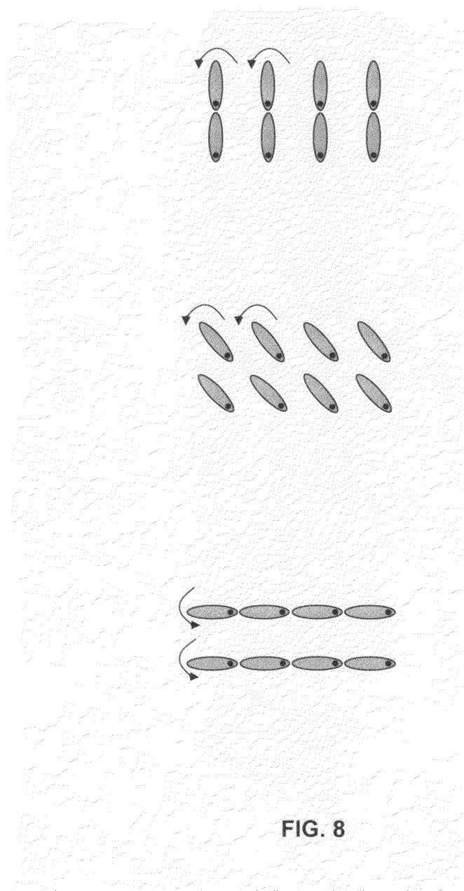

FIG. 8 illustrates examples of paddles with coordinated in phase motion to prevent mechanical interference. In this example, an array of eight paddles is shown at three points in time. The eight paddles are configured to move in phase with each other; that is, at each point in time, each paddle is oriented in the same direction (or is associated with the same angle when using the polar coordinate system described in FIG. 6A).

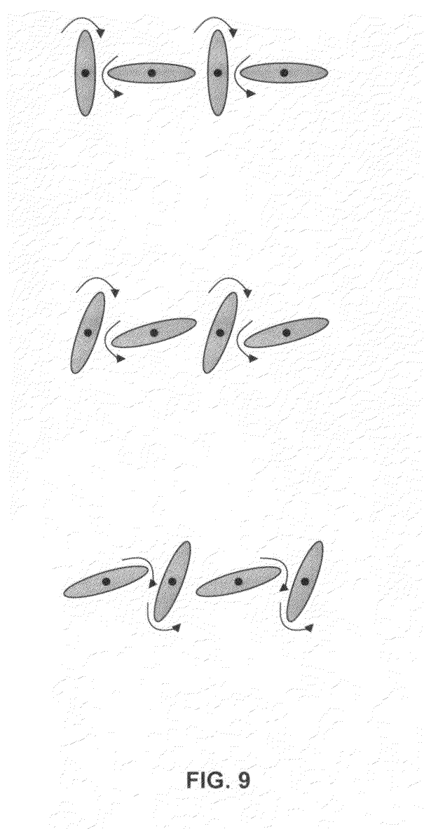

FIG. 9 illustrates examples of paddles with coordinated out of phase motion to prevent mechanical interference. In this example, an array of four paddles is shown at three points in time. The four paddles are configured to move out of phase with each other; that is, at each point in time, at least one paddle is not oriented in the same direction (or is associated with the same angle when using the polar coordinate system described in FIG. 6A) as the other paddles. In this case, even though the paddles move out of phase with each other, their phase difference (difference in angles) is such that they do not mechanically interfere with each other.

The display systems described herein have a naturally built in cooling system. Because the paddles are spinning, heat is naturally drawn off of the paddles. The farther the LED is from the axis of rotation, the more cooling it receives. In some embodiments, this type of cooling is at least 10× effective as systems in which LED tiles are stationary and in which an external cooling system is used to blow air over the LED tiles using a fan. In addition, a significant cost savings is realized by not using an external cooling system.

Although in the examples herein, the image to be displayed is provided in pixels associated with rectangular coordinates and the display area is associated with temporal pixels described in polar coordinates, the techniques herein can be used with any coordinate system for either the image or the display area.

Although rotational movement of paddles is described herein, any other type of movement of paddles may also be used. For example, a paddle may be configured to move from side to side (producing a rectangular sweep area, assuming the LEDs are aligned in a straight row). A paddle may be configured to rotate and simultaneously move side to side (producing an elliptical sweep area). A paddle may have arms that are configured to extend and retract at certain angles, e.g., to produce a more rectangular sweep area. Because the movement is known, a pixel map can be determined, and the techniques described herein can be applied.

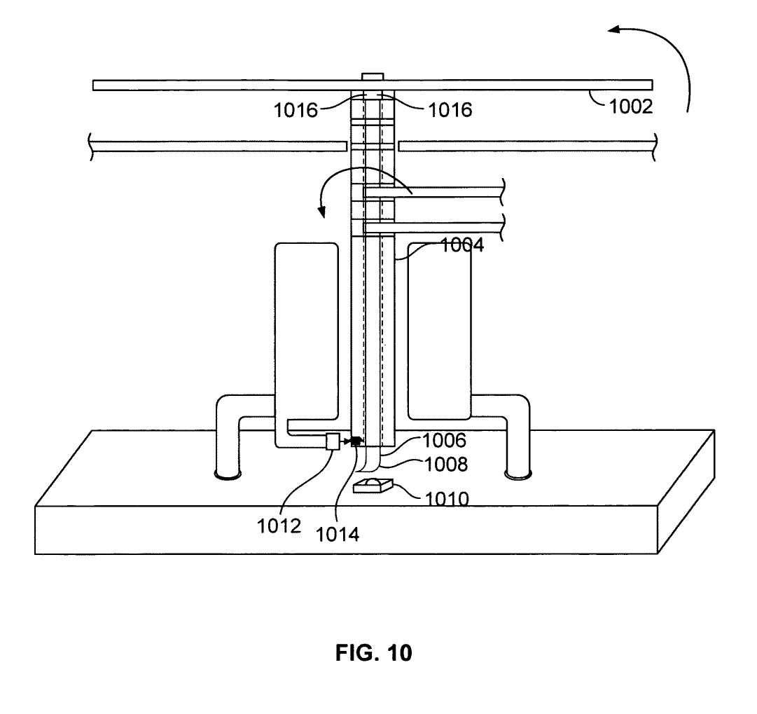

FIG. 10 is a diagram illustrating an example of a cross section of a paddle in a composite display. This example is shown to include paddle 1002, shaft 1004, optical fiber 1006, optical camera 1012, and optical data transmitter 1010. Paddle 1002 is attached to shaft 1004. Shaft 1004 is bored out (i.e., hollow) and optical fiber 1006 runs through its center. The base 1008 of optical fiber 1006 receives data via optical data transmitter 1010. The data is transmitted up optical fiber 1006 and transmitted at 1016 to an optical detector (not shown) on paddle 1002. The optical detector provides the data to one or more LED drivers used to activate one or more LEDs on paddle 1002. In some embodiments, LED control data that is received from LED control module 504 is transmitted to the LED driver in this way.

In some embodiments, the base of shaft 1004 has appropriate markings 1014 that are read by optical camera 1012 to determine the current angular position of paddle 1002. In some embodiments, optical camera 1012 is used in conjunction with angle detector 506 to output angle information that is fed to LED control module 508 as shown in FIG. 5.

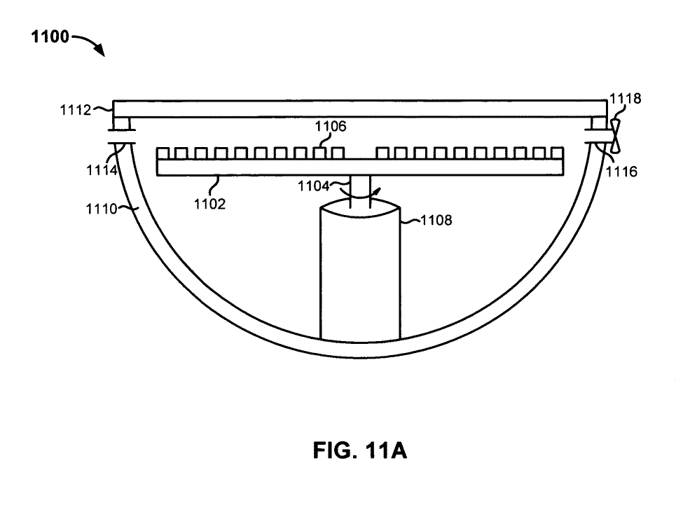

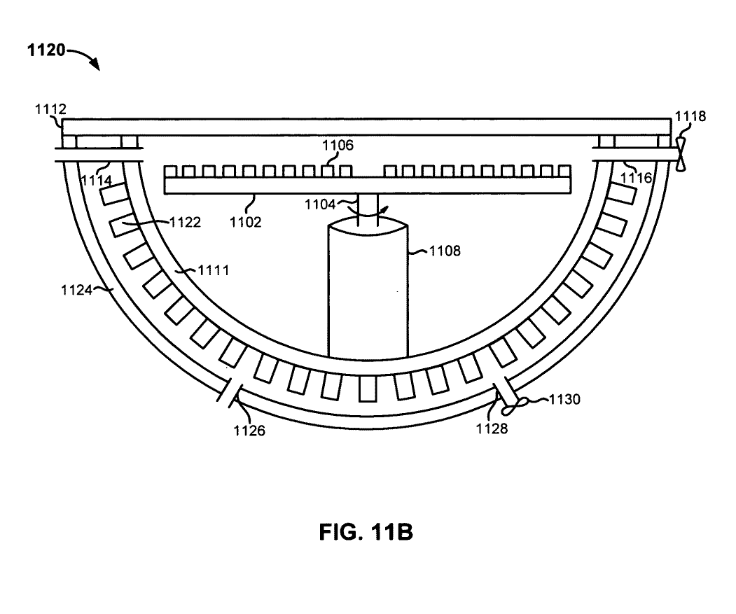

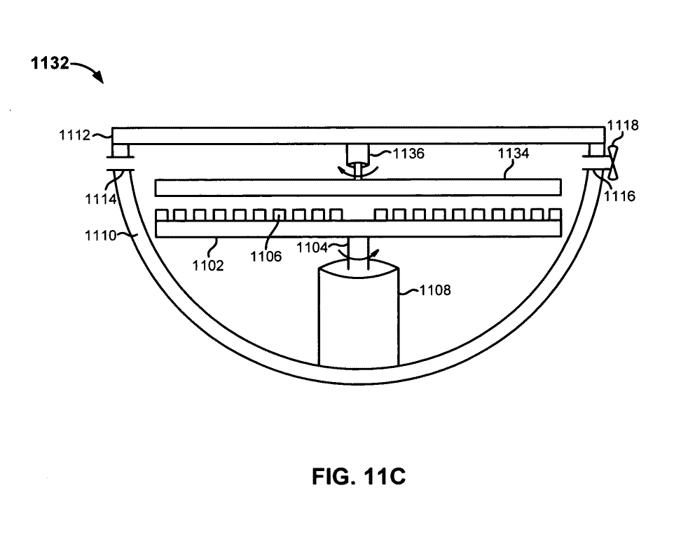

FIG. 11A is a diagram illustrating an embodiment of a cross section of a lighting fixture 1100. In some embodiments, lighting fixture 1100 comprises a high powered luminaire, such as a spotlight or stadium light. Lighting fixture 1100 comprises a paddle 1102 configured to rotate about axis of rotation 1104. In some embodiments, paddle 1102 comprises a printed circuit board (PCB). A plurality of lighting elements 1106, such as LEDs, is installed on paddle 1102. As used herein, a lighting element refers to any element that may be used to generate light. Although LEDs may be described in the examples herein, any appropriate lighting elements may be installed on paddle 1102, such as laser diodes, phosphors, cathode ray tubes, liquid crystals, any transmissive or emissive optical modulators, etc. As depicted, paddle 1102 is mounted on motor 1108, which is configured to rotate paddle 1102 about axis of rotation 1104. In various embodiments, power may be delivered to paddle 1102 using any appropriate technique, such as via brushes, a magnetic coupling, etc. The various components of lighting fixture 1100 are situated in the cavity of a casing, which in the given example comprises shell 1110 and cover lens 1112. Since the heat generated by lighting elements 1106 is dumped into the cavity of the casing of lighting fixture 1100, it is in many cases desirable to quickly exchange the air in the cavity to prevent it from excessively heating. Thus, in some embodiments, shell 1110 includes an inlet valve 1114 and an outlet valve 1116 for air flow between the cavity and the external environment. In some embodiments, a small fan 1118 is mounted at outlet valve 1116 to assist in driving air through the cavity and out of outlet valve 1116. In various embodiments, cover lens 1112 of lighting fixture 1100 may comprise any appropriate cover lens material for fixtures, such as plastic, glass, acrylic, etc. Although some of the main components of lighting fixture 1100 are illustrated and described, lighting fixture 1100 may include any one or more other appropriate components.

The rotating paddle configuration of lighting fixture 1100 facilitates the use of (high powered) LEDs as lighting elements without introducing the thermal issues typically associated with LEDs. The fan-like motion of paddle 1102 on which LEDs 1106 are mounted inherently introduces convective cooling in the cavity of lighting fixture 1100 and facilitates quick dissipation of the heat generated by LEDs 1106. Since the velocity of a fan blade is much higher than the velocity of the air being pushed out by the fan, convection based on the movement of LEDs 1106 (which are mounted on the fan, i.e., paddle 1102) is in some cases at least an order of magnitude higher than the convection that would result if an external fan were directly blown on stationary LEDs. As long as paddle 1102 is rotated at a high enough speed, the motion of the paddle creates a turbulent environment in the cavity with high heat transfer coefficients. The convection produced by the movement of paddle 1102 along with the flow of air in the cavity via inlet valve 1114 and outlet valve 1116 results in rapid air exchange in the cavity, preventing the ambient in the cavity from excessively heating and in many cases eliminating the need for other substantial cooling technologies such as large external fans and extensive heat sinks, which are often typically necessary in fixtures that use LEDs. Convective cooling based lighting fixtures, such as lighting fixture 1100, permit the use of more robust lighting technologies (e.g., LEDs) to create high power, energy efficient, low cost, compact, fast switching, variable intensity, long lasting, etc., lighting fixtures.

In addition to the convective cooling resulting from the motion of the paddle, in some embodiments, it may be desirable to further facilitate heat dissipation from the internal environment of the lighting fixture via any one or more other applicable techniques, a few examples of which are further described below. Such additional techniques may be useful, for instance, with respect to high power density lighting fixtures, such as compact, kilowatt range fixtures.

FIG. 11B is a diagram illustrating an embodiment of a cross section of a lighting fixture 1120. Lighting fixture 1120 of FIG. 11B is similar to lighting fixture 1100 of FIG. 11A with identical parts numbered with the same reference numerals. In the configuration of lighting fixture 1120, however, shell 1111 comprises a heat sink having a plurality of thermally conductive (e.g., metal) emanating heat sink fins 1122. Lighting fixture 1120 optionally includes an outer shell 1124, e.g., for handling and/or mounting purposes so that heat sink fins 1122 do not comprise the outermost surface of the fixture. In the given example, outer shell 1124 further includes an inlet valve 1126 and an outlet valve 1128 for evacuating the air between the heat sink and the outer shell. In some embodiments, outlet valve 1128 includes a fan 1130 to assist in driving air out of outlet valve 1128.

FIG. 11C is a diagram illustrating an embodiment of a cross section of a lighting fixture 1132. Lighting fixture 1132 of FIG. 11C is similar to lighting fixture 1100 of FIG. 11A with identical parts numbered with the same reference numerals. Lighting fixture 1132, however, additionally includes a plate 1134 situated above paddle 1102 that is rotated by motor 1136 in the opposite direction as paddle 1102 as depicted in FIG. 11C. The opposing motions of paddle 1102 and plate 1134 affect the relative air speed over paddle 1102 and in some cases produce a higher air velocity and as a result a higher convection than that achievable with just the motion of paddle 1102 (i.e., the configuration of FIG. 11A). Plate 1134 may comprise any appropriate transparent material, such as plastic, so that the light emitted by lighting elements 1106 on paddle 1102 transmits through plate 1134. Although not shown in FIG. 11C, in some embodiments, plate 1134 may include one or more air outlets for evacuating the air between paddle 1102 and plate 1134. For example, plate 1134 may include an air outlet at the center of plate 1134.

In various embodiments, a lighting fixture may comprise one or more paddles such as paddle 1102. Paddle 1102, which in some embodiments comprises a PCB, may be selected to be any appropriate shape and/or size. One or more different types of lighting elements 1106, such as LEDs, may be mounted on paddle 1102 in any appropriate configuration and/or pattern. In some embodiments, lighting elements 1106 are packed as densely as possible on paddle 1102. For example, a primary type of LED may be installed as densely as possible on a paddle, and one or more different, e.g., smaller, LEDs may be installed in the interstitial areas between the primary LEDs. In other embodiments, lighting elements may be more sparsely installed and/or mounted in prescribed patterns. In some embodiments, relatively fewer or no lighting elements are mounted at and/or near the center of paddle 1102 as depicted in the embodiments of FIGS. 11A-11C since the rotational speed of paddle 1102 is slowest near its center and as a result may not provide adequate convective cooling. Alternatively, in other embodiments, lighting elements may be installed at and/or near the center of paddle 1102 because the air flow resulting from the motion of other parts of the paddle is sufficient to dissipate the heat generated by the lighting elements at and/or near the center. Although rotational motion of paddle 1102 is described herein, a paddle 1102 may be configured to move in any other appropriate manner to facilitate convective cooling of the lighting elements installed on the paddle. For example, a paddle may be configured to translationally move horizontally and/or vertically, or a paddle may be configured to simultaneously move rotationally and translationally. In some embodiments, lighting elements 1106 of paddle 1102 comprise white LEDs that generate white light. In some embodiments, lighting elements 1106 of paddle 1102 comprise color LEDs that generate colored light. A lighting fixture with an arbitrary color control may be built using RGB lighting elements, e.g., RGB LEDs. Such lighting fixtures may be useful, for example, for high power stage or concert lighting.

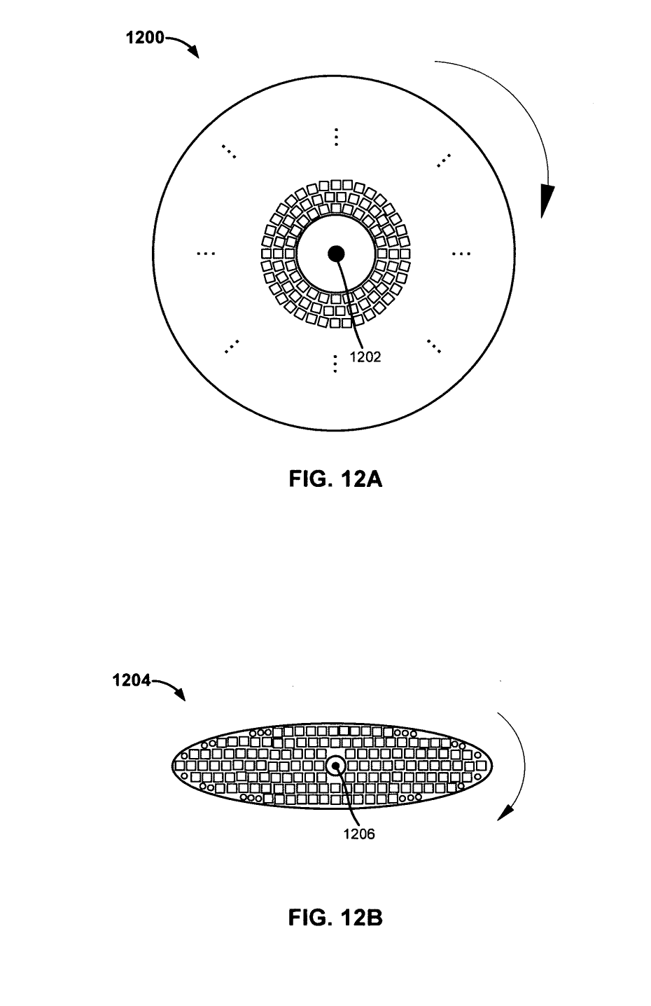

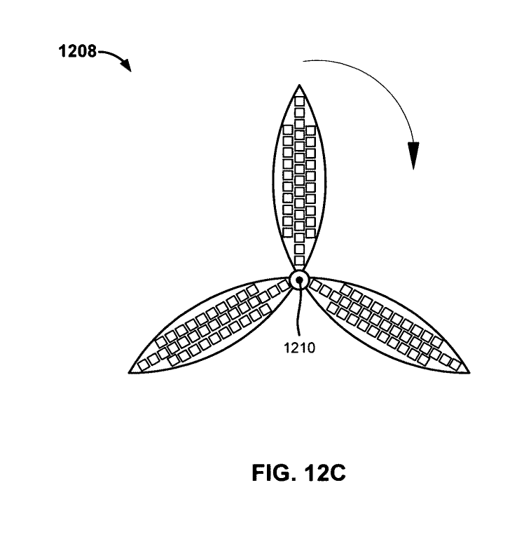

FIGS. 12A-12C illustrate examples of paddles having different sizes and shapes. Each of the paddles illustrated in FIGS. 12A-12C may comprise, for example, paddle 1102 of FIGS. 11A-11C. In each of the given examples, lighting elements are installed as densely as possible except around the center, i.e., the axis of rotation, of each paddle since this central portion of the paddle does not move or moves significantly slower than the outer portions of the paddle in these examples. In some embodiments, the central zone of each paddle includes an air outlet for moving heated air away from the vicinity of the paddle. FIG. 12A illustrates an embodiment of a circularly shaped paddle 1200. Paddle 1200 is configured to rotate about axis of rotation 1202. As depicted, no lighting elements are mounted around a central zone of paddle 1200 around its axis of rotation 1202. However, lighting elements are installed beyond this central zone and are represented by squares in the given figure. Although only some lighting elements are depicted in FIG. 12A, paddle 1200 is densely packed with lighting elements beyond its central zone as indicated by the ellipses in FIG. 12A. FIG. 12B illustrates an embodiment of an oblong paddle 1204. Paddle 1204 is configured to rotate about axis of rotation 1206. As depicted, no lighting elements are mounted around a central zone of paddle 1204 around its axis of rotation 1206. However, lighting elements are installed beyond this central zone. Paddle 1204 includes two different types of lighting elements which are represented by squares and circles in the given figure. FIG. 12C illustrates an embodiment of a fan-shaped paddle 1208. Paddle 1208 comprises three blades and is configured to rotate about axis of rotation 1210. As depicted, no lighting elements are mounted around a central zone of paddle 1208 around its axis of rotation 1210. However, lighting elements are installed beyond this central zone and are represented by squares in the given figure.

The size selected for paddle 1102 may depend, for example, on the desired output power of the lighting fixture. Compact fixtures with kilowatt range output powers are feasible using high power LEDs as the lighting elements. For example, several hundreds or thousands of high power (e.g., 4-5 watts) LEDs may be installed on a circularly shaped paddle having an 8-12 inch diameter, resulting in output powers in the kilowatt range.

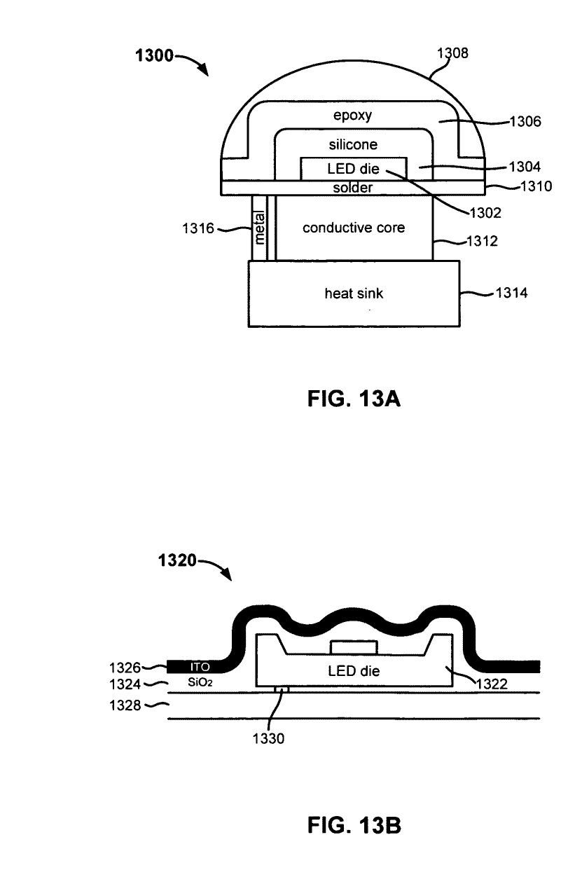

In some embodiments, any standard lighting elements 1106 may be installed on paddle 1102. For example, in some embodiments, standard, off-the-shelf LEDs 1106 are mounted on paddle 1102. FIG. 13A is a diagram illustrating an embodiment of a cross section of a portion of a standard LED package 1300. LED 1300 comprises an LED die 1302 topped with layers of organic potting materials such as silicone 1304 and epoxy 1306 and capped with an adiabatic plastic cover 1308. Solder 1310 is applied to the bottom surface of LED die 1302. LED die 1302 is mounted on a conductive core 1312 (e.g., a metal core PCB), which in turn is attached to a heat sink 1314. Metal contact 1316 provides a more direct connection between LED die 1302 and heat sink 1314. As depicted, the top portion of LED 1300 provides a thermal barrier, and heat is directed towards heat sink 1314. Thus, standard LEDs, such as LED 1300, are designed to be thermally managed by directing generated heat down to the backend of device.

In some embodiments, at least some of the lighting elements 1106 installed on paddle 1102 may be designed to facilitate heat dissipation via the top surfaces of the lighting elements. Such lighting elements may facilitate improved heat dissipation via convective cooling resulting from the motion of the lighting elements. For example, LEDs specially designed for convective cooling may have a top surface that comprises a thermally conductive, transparent polymer that drives heat up and out of the top surface. FIG. 13B is a diagram illustrating an embodiment of a cross section of a portion of an LED package 1320 that facilitates heat dissipation via the top surface of the LED. LED 1320 comprises an LED die 1322 sealed with a layer of SiO₂ (silicon dioxide) 1324 and a layer of ITO (indium tin oxide) 1326. SiO₂ and ITO are transparent, thermally conductive materials which in the given configuration direct heat out of the top surface of LED 1320. LED die 1322 is mounted to a substrate (e.g., a PCB) 1328 via metal contact 1330. In some embodiments, substrate 1328 does not require a conductive core and does not need to be coupled to a heat sink since heat is directed out through the SiO₂ and ITO layers of the device. In various embodiments, SiO₂ and ITO depositions may be performed at the die level for each LED or blanket depositions may be performed at the wafer level, i.e., for an entire PCB, for example, to reduce fabrication cost. Although one embodiment of an LED design is described, in other embodiments, any other appropriate design may be employed for an LED and/or LED package that facilitates heat dissipation via its front or top surface.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A lighting fixture, comprising:
a paddle configured to move in one or more directions; and
a set of one or more heat generating lighting elements mounted on the paddle;
wherein motion of the paddle results in convective cooling of the set of lighting elements.

2. The lighting fixture recited in claim 1, wherein the paddle is configured to rotate about an axis of rotation.

3. The lighting fixture recited in claim 1, wherein the paddle is configured to move translationally.

4. The lighting fixture recited in claim 1, further comprising a motor coupled to the paddle and configured to move the paddle.

5. The lighting fixture recited in claim 1, further comprising a casing in which one or more components of the lighting fixture including the paddle are situated.

6. The lighting fixture recited in claim 5, wherein the casing includes an inlet valve and an outlet valve for exchange of air between a cavity of the lighting fixture and an external environment.

7. The lighting fixture recited in claim 5, wherein the casing includes a cover lens.

8. The lighting fixture recited in claim 5, wherein the casing includes a heat sink shell.

9. The lighting fixture recited in claim 1, further comprising a plate positioned above the paddle and configured to move in an opposite direction as the paddle.

10. The lighting fixture recited in claim 1, wherein the set of lighting elements comprises light emitting diodes (LEDs).

11. The lighting fixture recited in claim 1, wherein the set of lighting elements comprises high powered light emitting diodes (LEDs).

12. The lighting fixture recited in claim 1, wherein the paddle comprises a printed circuit board (PCB).

13. The lighting fixture recited in claim 1, wherein the paddle is circularly shaped.

14. The lighting fixture recited in claim 1, wherein the lighting fixture comprises a set of one or more paddles including the paddle.

15. The lighting fixture recited in claim 1, wherein at least one lighting element comprises a lighting element configured to dissipate heat via a top surface of the lighting element.

16. The lighting fixture recited in claim 15, wherein the at least one lighting element comprises a light emitting diode die topped with one or more transparent, thermally conductive materials.

17. The lighting fixture recited in claim 16, wherein the one or more transparent, thermally conductive materials comprise one or more of silicon dioxide (SiO₂) and indium tin oxide (ITO).

18. The lighting fixture recited in claim 1, wherein the lighting fixture comprises one or more of a spotlight, a stadium light, a stage light, and a concert light.

19. A method for providing a lighting fixture, comprising:
configuring a paddle to move in one or more directions; and
mounting a set of one or more heat generating lighting elements on the paddle;
wherein motion of the paddle results in convective cooling of the set of lighting elements.

20. A light emitting diode, comprising:
a light emitting diode die;
a layer of silicon dioxide (SiO₂) deposited on the light emitting diode die; and
a layer of indium tin oxide (ITO) deposited on the layer of silicon dioxide.
